(19) United States
(12) Patent Application Publication
(10) Pub. No.: US 2008/0228327 A1
(43) Pub. Date: Sep. 18, 2008

(54) Solar cell outdoor control system

(76) Inventor: Kuo-Ching CHIANG, Linkou Township (TW)

Correspondence Address: SINORICA, LLC, 528 FALLSGROVE DRIVE, ROCKVILLE, MD, 20850, US

(21) Appl. No.: 12/047,680

(22) Filed: Mar. 13, 2008

(30) Foreign Application Priority Data
Mar. 16, 2007 (TW) 096109248

(51) Int. Cl. G05F 1/10; G05F 1/66

(52) U.S. Cl. 700/297

(57) ABSTRACT

The present invention discloses a solar cell outdoor control system comprising an outdoor under control device (OUCD) and a solar cell array coupled to the outdoor under control device to provide electricity to the outdoor under control device in a first state. A non-solar power is coupled to the outdoor under control device to provide electricity to the outdoor under control device in a second state; and a switch coupled to the solar cell array and non-solar power for switching there-between. The outdoor under control system includes traffic signal control system, outdoor bill board, outdoor monitoring system or outdoor wireless network access point. The solar cell outdoor control system further comprises a wireless transceiver to transmit and/or receive data to/from an external device. The solar cell outdoor control system further comprises a sensor to detect the first state or the second state.

### FIELD OF INVENTION

The present invention relates to a digital player, and more particularly to a digital content player with solar cell array.

### BACKGROUND

The trend of consumer product is to reduce the size of the device and the marking of electronic product is driven by the needs of multi-function, higher speed and lighter weight. The telecommunication is developed rapidly for the last decade. It is because that the green house effect is serious than ever, the energy policy therefore becomes a concerned issue in the world. One of the energy policies is energy-saving all over the world. However, all of the digital players are powered by conventional power energy and most of the outdoor device is power by conventional power and wired data transmission. The real-time wireless remote data update and control is impossible.

### SUMMARY

The present invention discloses a solar cell outdoor control system comprising an outdoor under control device (OUCD); a solar cell array coupled to the outdoor under control device to provide electricity to the outdoor under control device in a first state; an non-solar power coupled to the outdoor under control device to provide electricity to the outdoor under control device in a second state; and a switch coupled to the solar cell array and non-solar power for switching there-between. The outdoor under control system includes traffic signal control system, outdoor bill board, outdoor monitoring system or outdoor wireless network access point. The solar cell outdoor control system further comprises a wireless transceiver to transmit and/or receive data to/from an external device, wherein the protocol of the wireless transceiver includes Bluetooth, WiFi, WiMax, IR or 802.11 standards. The solar cell outdoor control system further comprises a sensor to detect the first state or the second state.

Alternatively, the present invention provides an outdoor control system comprising an outdoor under control device (OUCD) having a processing unit and a display coupled to the processing unit to display content, wherein the outdoor under control device includes an outdoor electronic bill board; a wireless transceiver coupled to the processing unit solar cell array coupled to the outdoor under control device to transmit and/or receive data; and power source coupled to the outdoor under control device to provide electricity. The protocol of the wireless transceiver includes Bluetooth, WiFi, WiMax, IR or 802.11 standards. The outdoor control system further comprises a switch coupled to a solar cell array and an non-solar power for switching there-between. The outdoor control system further comprises a detector coupled to the processing unit to detect environment condition. The display includes LED display.

In another embodiment, the present invention discloses a control system comprising an under control device (UCD) having a processing unit and a display coupled to the processing unit to display content, wherein the under control device includes an outdoor electronic digital displayer attached on an inner or outer wall (frame) of artificiality; a wireless transceiver coupled to the processing unit solar cell array coupled to the outdoor under control device to transmit and/or receive data; and a solar cell array coupled to the under control device to provide electricity. The control system further comprises a sensor to detect environment condition.

The present invention provides a digital content player comprising: a processing unit; a digital playing module coupled to the processing unit for playing digital content; a display coupled to the processing unit for displaying the digital content; a transceiver coupled to the processing unit for receiving or transmitting the digital content. A solar cell array is set on a surface of the digital content player. RSS module may be embedded in memory of the digital content player. Alternatively, the digital playing module includes a digital photo module, MP3 or MP4 playing module embedded in the digital content player. The digital content player includes a card reader coupled to the processing unit.

A digital content player comprises: a processing unit; a digital playing module coupled to the processing unit for playing digital content; a display coupled to the processing unit for displaying the digital content; a solar cell array set on a surface of the digital content player. The player also includes a transceiver coupled to the processing unit for receiving or transmitting the digital content. RSS module is embedded in memory of the digital content player. The digital playing module includes a digital photo module a MP3 or MP4 playing module embedded in the digital content player.

A digital content player comprises: a processing unit; a digital photo playing module coupled to the processing unit for playing digital photo; a display coupled to the processing unit for displaying the digital photo; a solar cell array set on a surface of the digital content player. A transceiver is coupled to the processing unit for receiving or transmitting digital content. RSS module is embedded in memory of the digital content player. A card reader is coupled to the processing unit. MP3 or MP4 playing module embedded in the digital content player.

A digital content player comprises: a processing unit; a digital photo playing module coupled to the processing unit for playing digital photo; a display coupled to the processing unit for displaying the digital photo; a transceiver coupled to the processing unit for receiving or transmitting digital content. RSS module is embedded in memory of the digital content player. The digital content player includes a card reader coupled to the processing unit. MP3 or MP4 playing module is embedded in the digital content player.

### BRIEF DESCRIPTION OF THE DRAWINGS

The foregoing aspects and many of the attendant advantages of this invention will become more readily appreciated as the same becomes better understood by reference to the following detailed descriptions, when taken in conjunction with the accompanying drawings, wherein:

FIG. 1 is a diagram illustrating the control system according to the present invention.

FIG. 2 is a diagram illustrating control system according to the present invention.

FIG. 3 is a diagram illustrating control system according to the present invention.

FIG. 4 is a diagram illustrating portable device according to the present invention.

FIG. 5 is a diagram illustrating digital content player according to the present invention.

### DETAILED DESCRIPTION OF THE PRESENT INVENTION

The present invention discloses a solar cell outdoor control system comprising an outdoor under control device (OUCD); a solar cell array coupled to the outdoor under control device to provide electricity to the outdoor under control device in a first state; an non-solar power coupled to the outdoor under control device to provide electricity to the outdoor under control device in a second state; and a switch coupled to the solar cell array and non-solar power for switching there-between. The solar cell outdoor control system further comprises a wireless transceiver to transmit and/or receive data to/from an external device, wherein the protocol of the wireless transceiver includes Bluetooth, WiFi, WiMax, IR or 802.11 standards. The solar cell outdoor control system further comprises a sensor to detect the first state or the second state. The first state could be a day time or sunny day. The second state could be a night time, rainy day or the like. The outdoor under control system includes traffic signal control system, outdoor bill board, outdoor monitoring system or outdoor wireless network access point.

The portable device according to the present invention includes portable remoter cellar, PDA and smart phone. The above device includes RF module for local or wild area network access. The portable device may be coupled network via access point by wired or wireless method. One of the characteristics is a portable device with network (cellar network or internet) access capability. The data transmitted by the portable device include digital data, audio signal, video signal or the combination. The protocol of the communication may be Bluetooth, WiFi, 802.11 compatible, WiMax (Worldwide Interoperability for Microwave Access).

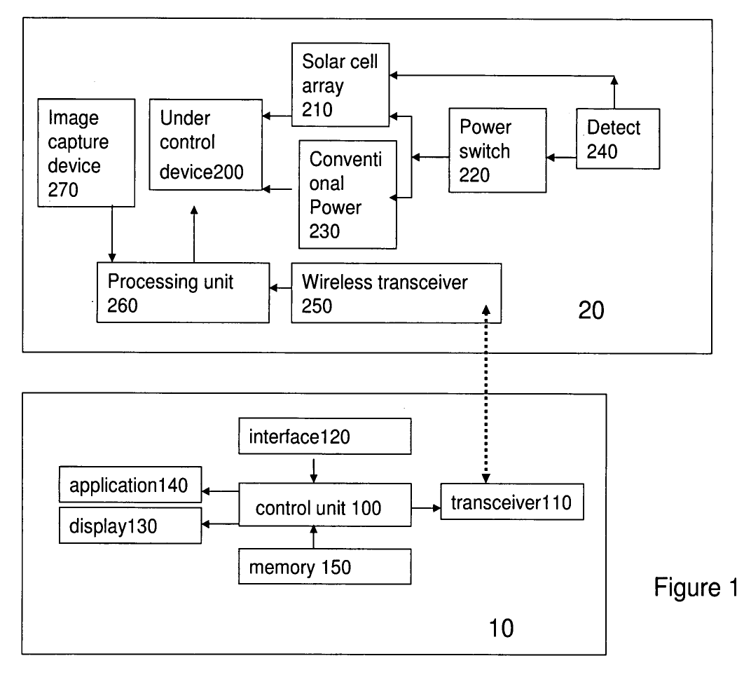

FIG. 1 illustrates the functional diagram of the present invention. It includes an outdoor under-control device (OUCD) 200 that includes traffic signal, out-door image (video) capture device, outdoor electronic bill board or out-door access point (or router). It is because these device is typically set or arranged out the building and the numbers of these device are quite lots. The devices consume a lot of energy. Based on the energy-saving consideration, it is not economic at all. A solar cell array 210 is coupled to the outdoor under-control device 200 and a conventional power source 220 is optionally coupled to the outdoor under-control device 200 as well. When the sun-light is not enough or it rains, the conventional power source 220 may be employed to provide the necessary power. If an illumination is used, the light source is preferably LED array to reduce the power consumption. A switch 220 is coupled to the conventional power source 220 and the solar cell array 210 for switching there between. A detector 240 is coupled to the switch 220 for determining the action of power switch. The aforementioned detector 240 could be a moisture detector, solar cell array power detector or photo sensor.

A process (control) unit 260 is optionally coupled to the under control device and a wireless or wired transceiver 250 to allow the user control the outdoor under control device wirelessly. For example, the user (monitor or controller) may control the signal light dynamically when an accident occurs or during the rash-hours. The protocol of the communication may be Bluetooth, WiFi, 802.11 compatible, WiMax (Worldwide Interoperability for Microwave Access) or IR. An image (video) capture device 270 is optionally set and coupled to the process (control) unit 260 to monitor the real-time situation (for instance traffic conditions) in order to remote control. The captured image is transmitted to the remote terminal 10 by the transceiver 250. The protocol of the communication could be 3G or above communication standard.

The remote terminal 10 could be fixed or moveable for remote or in-situ control. The remote terminal 10 includes control unit 100, interface 120 coupled to the control unit 100 to allow the user input instruction. Application program 140 and/or display 130, memory are coupled to the control unit 100. These are not the features of the present invention, therefore, the description is omitted. The user may also employ the transceiver 110 to control the outdoor under control device. The remote terminal 10 could be cellar, PDA, smart phone, computer, notebook, or the like.

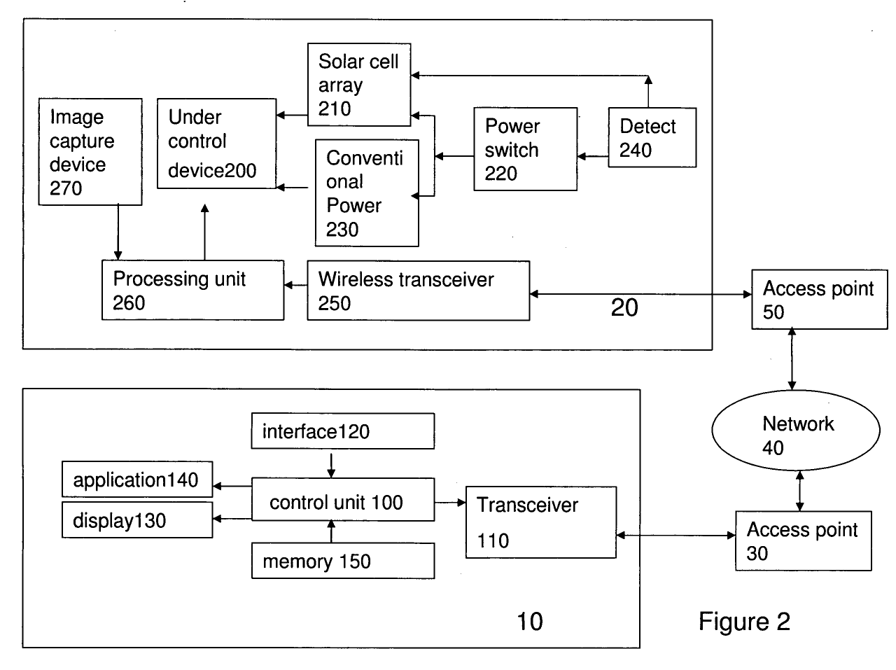

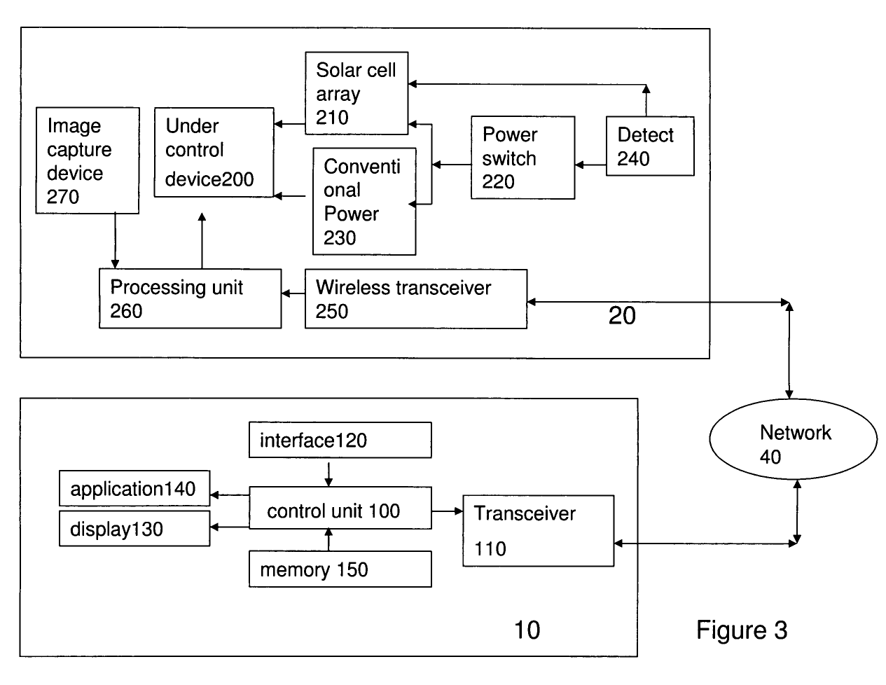

Please refer to FIG. 2, it illustrates that the user couples to the outdoor under control device through access point 30 and internet 40. FIG. 3 is the wired control embodiments. A MODEM 1100, 2500 and the network interface 1110, 2510 are incorporated. A conventional control electronic device may be used.

In normal status, the traffic signal is set to be powered by solar cell array to save energy. As mentioned above, the detector is provided to sense the solar cell battery level or environment conditions for making a proper power arrangement. The wireless transmission module allows the user remote or mobile control the OUCD without the geography constrains.

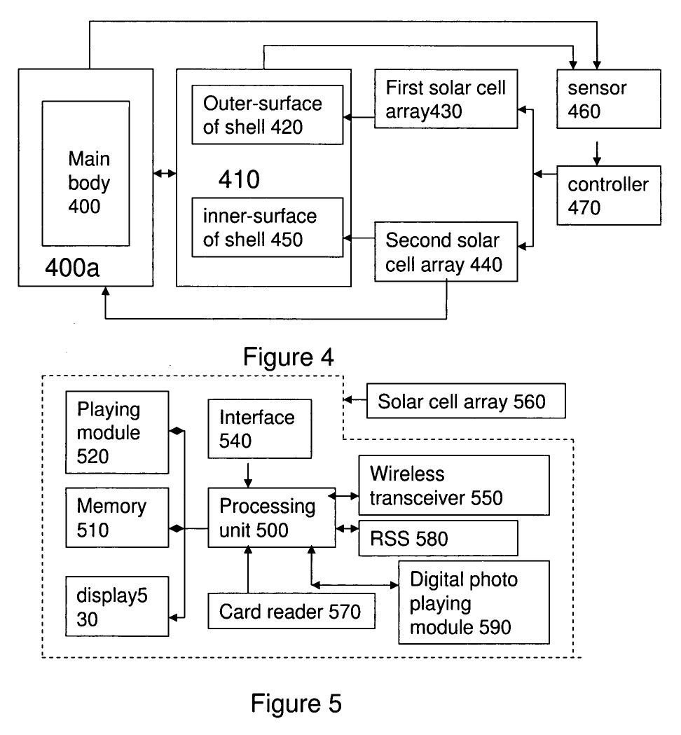

Further embodiment is shown in FIG. 4, the solar cell may also be employed for notebook, media player, electronic book, digital photo-frame. In the case of notebook 400, a flappable display panel 410 is connected to the main body 400 of the notebook 410. The flappable display panel 410 is used to carry the LCD panel. The first solar cell array 430 is arranged on the outside surface 420 of the flappable display panel 410 to receive the light when the panel is close. A second solar cell array 440 is set at least one of the following areas, inner surface 450 of the flappable display panel 410, non-keyboard area 400a of the main body 400, to receive the light when the flappable display panel 410 is opened. A sensor 460 may be employed to detect the status of the flappable display panel 410 for controlling the actions of the first and second solar cell array 430, 440.

Please refer to FIG. 5, a wireless digital content reader (or book) is shown which includes a process unit 500, a digital reader module 520 coupled to the process unit 500 to allow the user to read the digital content displayed on the display 530 of the device. A wireless transmitter 550 coupled to the process unit 500 for receiving or transmitting data (digital content) from/to external device wirelessly. Memory 510 and user interface 540 are also required. The wireless digital content reader includes the solar cell array coupled to the process unit 500 to provide power. It includes RSS (Really Simple Syndication) module 580 coupled to the process unit 500. Widget module is also embedded in the memory and coupled to the process unit 500 to allow the user may subscribe desired information from network service provider. The RSS is one of the format to allow the user subscribe information from internet once the user knows the location of the RSS. The subscribed information will be transmitted automatically without checking the website through computer to subscribe digital news, magazine, paper or book. A digital photo frame module 590 may be embedded in the memory of the device. Alternatively, it may be an individual device. A card reader 570 is employed to couple to the process unit 500 to allow the user insert a memory card with digital content. The display could be a LCD or electronic paper.

The present invention provides a wireless digital photo display device including a digital photo frame module 590 coupled to the process unit to display the digital photo or video. The display is coupled to the d process unit to display the digital photo. Wireless transceiver is also employed. Alternatively, the present invention discloses a wireless media player to display MP3 and/or MP4 file. It includes a MP3 and/or MP4 module coupled to the process unit to display the digital audio or video file. The display is coupled to the d process unit to display the digital photo. Wireless transceiver and speaker may be also employed.

Some parameters of the preferred embodiment for the present invention are illustrated in Table 1 and Table 2 as follows. As will be understood by persons skilled in the art, the foregoing parameters of the present invention is illustrative of the present invention rather than limiting the present invention.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. A solar cell outdoor control system comprising:
an outdoor under control device (OUCD);
a solar cell array coupled to said outdoor under control device to provide electricity to said outdoor under control device in a first state;
an non-solar power coupled to said outdoor under control device to provide electricity to said outdoor under control device in a second state; and
a switch coupled to said solar cell array and non-solar power for switching there-between.

2. The system of claim 1, wherein said outdoor under control system includes traffic signal control system, outdoor bill board, outdoor monitoring system or outdoor wireless network access point.

3. The system of claim 1, wherein said solar cell outdoor control system further comprises a wireless transceiver to transmit and/or receive data to/from an external device.

4. The system of claim 1, wherein protocol of said wireless transceiver includes Bluetooth, WiFi, WiMax, IR or 802.11 standards.

5. The system of claim 1, wherein said solar cell outdoor control system further comprises a sensor to detect said first state or said second state.

6. An outdoor control system comprising:
an outdoor under control device (OUCD) having a processing unit and a display coupled to said processing unit to display content, wherein said outdoor under control device includes an outdoor electronic bill board;
a wireless transceiver coupled to said processing unit solar cell array coupled to said outdoor under control device to transmit and/or receive data; and
power source coupled to said outdoor under control device to provide electricity.

7. The system of claim 6, wherein protocol of said wireless transceiver includes Bluetooth, WiFi, WiMax, IR or 802.11 standards.

8. The system of claim 6, wherein power source includes solar cell array.

9. The system of claim 8, wherein said outdoor control system further comprises a switch coupled to said solar cell array and an non-solar power for switching there-between.

10. The system of claim 6, wherein said outdoor control system further comprises a detector coupled to said processing unit.

11. The system of claim 6, wherein said display includes LED display.

12. A control system comprising:
an under control device (UCD) having a processing unit and a display coupled to said processing unit to display content, wherein said under control device includes an outdoor electronic digital displayer attached on an inner or outer wall (frame) of artificiality;
a wireless transceiver coupled to said processing unit solar cell array coupled to said outdoor under control device to transmit and/or receive data; and
a solar cell array coupled to said under control device to provide electricity.

13. The system of claim 12, wherein protocol of said wireless transceiver includes Bluetooth, WiFi, WiMax, IR or 802.11 standards.

14. The system of claim 12, wherein said control system further comprises a sensor to detect environment condition.
